(19) United States
(12) Patent Application Publication
(10) Pub. No.: US 2007/0003251 A1
(43) Pub. Date: Jan. 4, 2007

(54) Multimedia data reproducing apparatus, audio data receiving method and audio data structure therein

(76) Inventors: Hyun-Kwon Chung, Seoul (KR); Seong-Jin Moon, Suwon-si (KR); Bum-Sik Yoon, Seongnam-si (KR)

Correspondence Address: STEIN, MCEWEN & BUI, LLP, 1400 EYE STREET, NW, SUITE 300, WASHINGTON, DC, 20005, US

(21) Appl. No.: 10/556,126

(22) PCT Filed: May 10, 2004
(86) PCT No.: PCT/KR04/01073

§ 371 Date: Nov. 9, 2005

(30) Foreign Application Priority Data
May 10, 2003 (KR) 10-2003-0029623

(51) Int. Cl. H04N 7/00

(52) U.S. Cl. 386/96

(57) ABSTRACT

Provided are a multimedia data decoding apparatus, a method of receiving audio data using an HTTP protocol and an audio data structure used for the apparatus and method. The multimedia data reproducing apparatus comprises a decoder receiving AV data, decoding the AV data, and reproducing the AV data in synchronization with predetermined markup data related to the AV data; and a markup resource decoder receiving location information of video data being reproduced by the decoder, calculating a reproducing location of the markup data related to the video, and transmitting the reproducing location of the markup data to the decoder. Audio data is received using the HTTP protocol, not a complex audio/video streaming protocol, and is output in synchronization with video data.

### CROSS-REFERENCE TO RELATED APPLICATIONS

This application claims the benefit of PCT International Patent Application No. PCT/KR2004/001073, filed May 10, 2004, and Korean Patent Application No. 2003-29623, filed May 10, 2003, in the Korean Intellectual Property Office, the disclosures of which are incorporated herein by reference.

### BACKGROUND OF THE INVENTION

1. Field of the Invention

Aspects of the present invention relate to audio data transmission, and more particularly, to a multimedia data reproducing apparatus, a method of receiving audio data using a hyper text transport protocol (HTTP) and an audio data structure used for the apparatus and method.

2. Description of the Related Art

FIG. 1 illustrates a process of requesting an audio file from a server and receiving the requested file by a terminal receiving data over the Internet.

Referring to FIG. 1, web browser software, such as Internet Explorer, is installed on a terminal 110 receiving data over the Internet. The terminal 110 can request web data stored on a server 120 to be transmitted using a predetermined protocol via the web browser software.

When the terminal 110 requests an audio.ac3 file, which is a kind of compressed audio file, the terminal 110 transmits a file request message 130 to the server 120. The server 120 transmits a response message 140 to the terminal 110 and then transmits audio data to the terminal 110. Here, a generally used protocol is an HTTP protocol. The received audio data is temporarily stored in a buffer memory included in the terminal 110, decoded by a decoder reproducing data, and output as analog audio.

In detail, markup resource data includes HTML files, image files, script files, audio files, and video files. The terminal 110, which receives the markup resource data, is connected to a web server, on which the markup resource data is stored, using the HTTP protocol. For example, if a user wants the terminal 110 to access a site ‘www.company.com’ and download an audio.ac3 file, the terminal 110 executes the browser and accesses the server 120 by typing in ‘http://www.company.com’ in a Uniform Resource Location (URL) field. After accessing the server 120, the file request message 130 is transmitted to the server 120. The server 120 transmits the response message 140 to the terminal 110.

The server provides the stored markup resource data. Since the terminal 110 requests the audio.ac3 file, the server 120 transmits the audio.ac3 file to the terminal 110. The terminal 110 stores the received audio.ac3 file in the buffer memory. The decoder included in the terminal 110 decodes the audio.ac3 file stored in the buffer memory and outputs the decoded file as analog audio.

In a conventional method of transmitting markup resource data, the terminal 110 requests a complete file and the server 120 transmits the complete file, or when a large file, such as audio data, is transmitted, the terminal 110 requests the file by defining in advance a range to be transmitted and the server 120 transmits a portion of the file corresponding to the range.

However, when data is encoded temporally, and when data to be transmitted is defined according to a time at which the data is to be transmitted, as in audio data, it is difficult to use the conventional method. For example, if various kinds of audio files, such as MP3, MP2, and AC3, exist, when the same time information of the audio files is transmitted to the server 120, and when audio data corresponding to the time information is requested, it is difficult to use the conventional method since locations of files corresponding to the time information are different for each kind of audio file.

### SUMMARY OF THE INVENTION

An aspect of the present invention provides a method of receiving audio data using an HTTP protocol, not a complex audio/video streaming protocol, a structure of received audio meta data, and a structure of audio data.

Another aspect of the present invention also provides a multimedia data reproducing apparatus capable of reproducing audio data in synchronization with audio data and video stored in a DVD.

As described above, according to embodiments of the present invention, audio data is received using an HTTP protocol, not a complex audio/video streaming protocol, and output in synchronization with video data.

For example, a DVD includes movie contents and video in which a director explains producing procedures of the movie (director's cut). The director's explanation is commonly produced in one language. Accordingly, a film producing company must produce a special DVD to provide content in another language, e.g., Korean content. Therefore, since only audio produced with various languages is downloaded over the Internet and output in synchronization with original DVD video, problems of producing a special DVD can be overcome.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional process of requesting an audio file from a server and receiving the requested file by a terminal receiving data over the Internet;

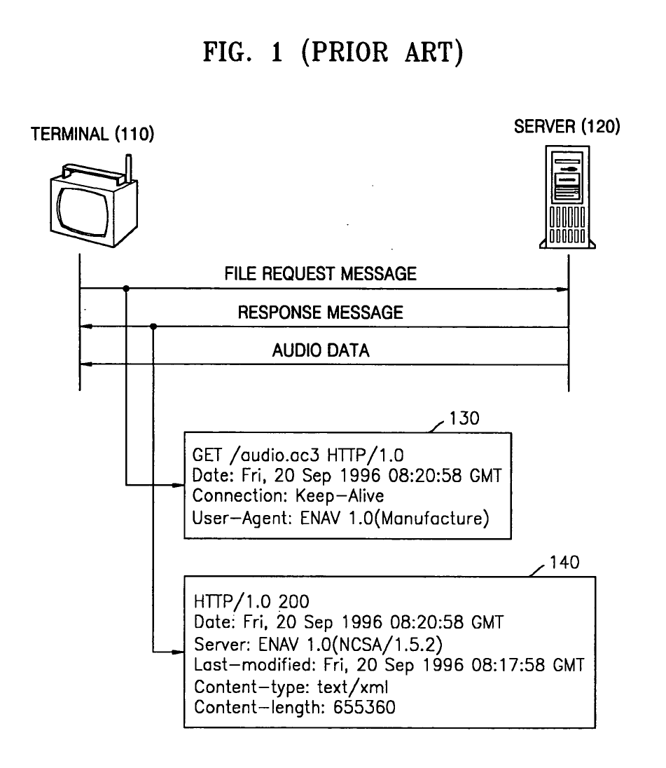

FIG. 2 is a block diagram of a terminal;

FIG. 3 is a block diagram of a server;

FIG. 4 illustrates a process by which a terminal receives audio data from a server using meta data;

FIG. 5 is a table showing request messages and response messages used to communicate between a terminal and a server;

FIG. 6 illustrates a configuration of an audio.ac3 file;

FIG. 7 is a block diagram of a terminal including a ring type buffer;

FIGS. 8A and 8B are detailed diagrams of chunk headers according to embodiments of the present invention;

FIG. 9 illustrates a process of reading chunk audio data stored in a buffer, decoding the chunk audio data, synchronizing the decoded chunk audio data with video data, and outputting the synchronized audio and video data; and

FIG. 10 is a flowchart illustrating a method of calculating an initial position of audio data according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to an aspect of the present invention, there is provided a multimedia data reproducing apparatus comprising: a decoder receiving AV data, decoding the AV data, and reproducing the AV data in synchronization with predetermined markup data related to the AV data; and a markup resource decoder receiving location information of video data being reproduced by the decoder, calculating a reproducing location of the markup data related to the video, and transmitting the reproducing location of the markup data to the decoder.

According to another aspect of the present invention, there is provided a method of receiving audio data, the method comprising: receiving meta data including attribute information of audio data from a server; calculating initial position information of the audio data, transmission of which is requested, according to the attribute information included in the meta data; and transmitting the calculated initial position information to the server and receiving the audio data corresponding to the initial position.

According to another aspect of the present invention, there is provided a method of calculating a location of audio data, the method comprising: converting initial time information of data, transmission of which is requested, into the number of frames included in the audio data; converting the number of frames into initial position information of a chunk, which is a transmission unit of the audio data; and calculating byte position information corresponding to the initial chunk position information.

According to another aspect of the present invention, there is provided a recording medium having recorded thereon audio meta data comprising: information regarding a compression format of audio data; information regarding a number of bytes allocated to a single frame included in the audio data; time information allocated to the single frame; information regarding a size of chunk data, which is a transmission unit of the audio data, and information regarding a size of a chunk header; and location information regarding a server in which the audio data is stored.

According to another aspect of the present invention, there is provided a recording medium having recorded thereon an audio data structure comprising: a chunk header field including synchronization information determining a reference point in time for reproducing the audio data; and an audio data field in which frames forming the audio data are stored.

According to another aspect of the present invention, there is provided a computer readable medium having recorded thereon a computer readable program for performing a method of receiving audio data comprising receiving meta data including attribute information of audio data from a server; calculating an initial position information of the audio data, transmission of which is requested, according to the attribute information included in the meta data; and transmitting the calculated initial position information to the server and receiving the audio data corresponding to the initial position.

According to another aspect of the invention, there is provided a computer readable medium having recorded thereon a computer readable program for performing a method of calculating a location of audio data, comprising: converting initial time information of data, transmission of which is requested, into a number of frames included in the audio data; converting the number of frames into initial position information of a chunk which is a transmission unit of the audio data; and calculating byte position information corresponding to the initial chunk information.

The chunk header field may include at least one of a pack header field and a system header field, which are defined in an MPEG-2 standard. The chunk header field may include a TS packet header field, which is defined in the MPEG-2 standard. The chunk header field may also include a PES header field, which is defined in the MPEG-2 standard.

Hereinafter, the present invention will now be described more fully with reference to the accompanying drawings, in which exemplary embodiments of the invention are shown.

An example of a file request message used when a terminal requests a complete audio.ac3 file from a server is:

GET/audio.ac3 HTTP/1.0

Date: Fri, 20 Sep. 1996 08:20:58 GMT

Connection: Keep-Alive

User-Agent: ENAV 1.0(Manufacturer).

An example of a response message that the server transmits to the terminal in response to the file request message is:

HTTP/1.0 200

Date: Fri, 20 Sep. 1996 08:20:58 GMT

Server: ENAV 1.0(NCSA/1.5.2)

Last-modified: Fri, 20 Sep. 1996 08:17:58 GMT

Content-type: text/xml

Content-length: 655360.

An example of file request message used when the terminal requests a certain range of the audio.ac3 file from the server is:

GET/audio.ac3HTTP/1.0

Date: Fri, 20 Sep. 1996 08:20:58 GMT

Connection: Keep-Alive

User-Agent: ENAV 1.0(Manufacturer)

Range: 65536-131072.

If the terminal requests data from a 65536 byte position to a 131072 byte position of the audio.ac3 file as shown above, an example of a response message from the server is:

HTTP/1.0 200

Date: Fri, 20 Sep. 1996 08:20:58 GMT

Server: ENAV 1.0(NCSA/1.5.2)

Last-modified: Fri, 20 Sep. 1996 08:17:58 GMT

Content-type: text/xml

Content-length: 65536.

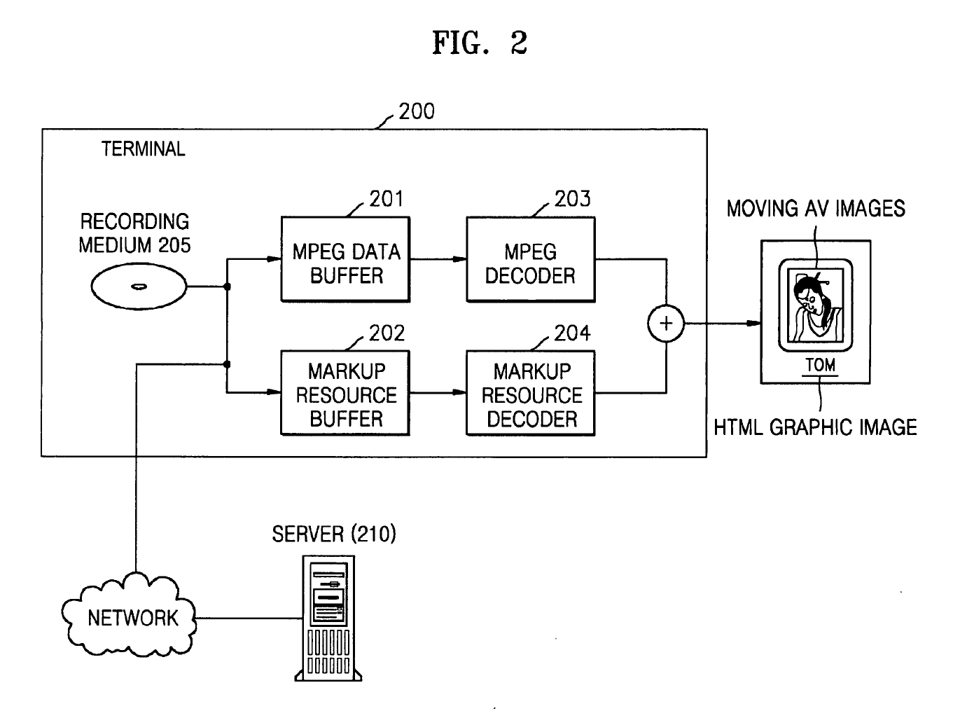

FIG. 2 is a block diagram of a terminal. Referring to FIG. 2, a terminal 200 includes an MPEG data buffer 201, a markup resource buffer 202, an MPEG decoder 203, and a markup resource decoder 204. The terminal 200 can receive data from a server 210 via a network or from a recording medium 205 such as a disc.

A markup resource stored in the server 210 is transmitted to the markup resource buffer 202, and decoded by the markup resource decoder 204. Video data stored in the recording medium 205 is transmitted to the MPEG data buffer 201 and decoded by the MPEG decoder 203. The decoded video and markup resource are displayed together.

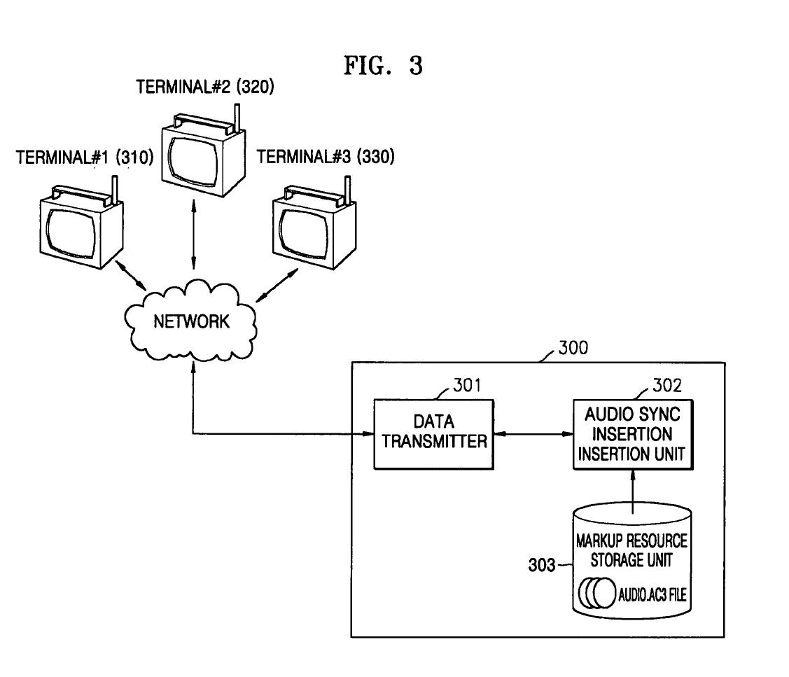

FIG. 3 is a block diagram including a server 300. The server 300 includes a data transmitter 301, an audio sync signal insertion unit 302, and a markup resource storage unit 303. The data transmitter 301 transmits data to and receives data from a plurality of terminals, e.g., 310, 320, and 330. The audio sync signal insertion unit 302 inserts a sync signal for simultaneously reproducing audio and video by synchronizing the audio and video when the video is reproduced. The markup resource storage unit 303 stores markup resource data such as an audio.ac3 file.

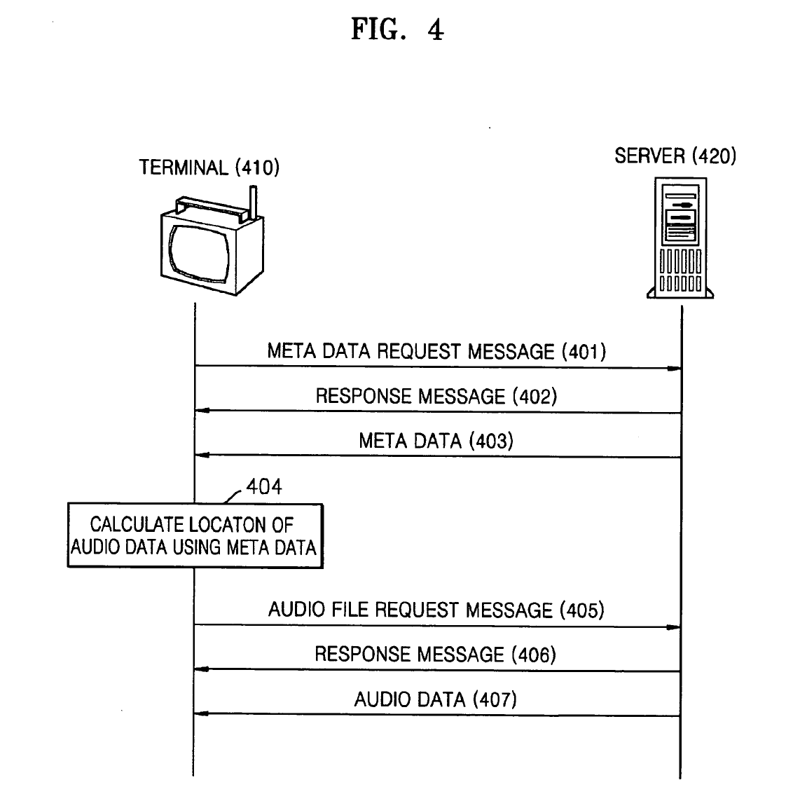

FIG. 4 illustrates a process by which a terminal receives audio data from a server using meta data. A terminal 410 transmits a request message requesting meta data (audio.acp) to a server 420 in operation 401. The server 420 transmits a response message to the terminal 410 in response to the request message in operation 402. Then, the server 420 transmits the meta data to the terminal 410 in operation 403.

An example of the audio meta data audio.acp file is:

<media version = ‘1.0’ >
<data name = ‘format’ value = ‘audio/ac3’ />
<data name = ‘byteperframe’ value = ‘120’ />
<data name = ‘msperframe’ value = ‘32’ />
<data name = ‘chunktype’ value = ‘1’ />
<data name = ‘chunksize’ value = ‘8192’ />
<data name = ‘chunkheader’ value = ‘21’ />
<data name = ‘location’ value = ‘http://www.company.com/ac3/audio.ac3’ />
</media>.

As indicated above, the audio meta data includes an audio file format, a number of bytes per frame, a time for reproducing a single frame, a chunk type, a size of a chunk, a size of a chunk header, and a location of stored audio data. The terminal 410 stores the received audio meta data audio.acp file in a buffer memory included in the terminal 410. Here, the audio.acp meta data can be read from a disc or received from a server via a network. The audio.acp meta data can also be transmitted as any type including a file type.

The terminal 410 receives the audio.acp meta data and calculates a location of audio data to be read in operation 404. A method of calculating the location of the audio data will be described below. When the location is calculated, the terminal 410 transmits a message requesting the actual audio file audio.ac3 to the server 420 in operation 405. The server transmits a response message to the terminal 410 in response to the audio file request message in operation 406 and then transmits audio.ac3 audio data to the terminal in operation 407.

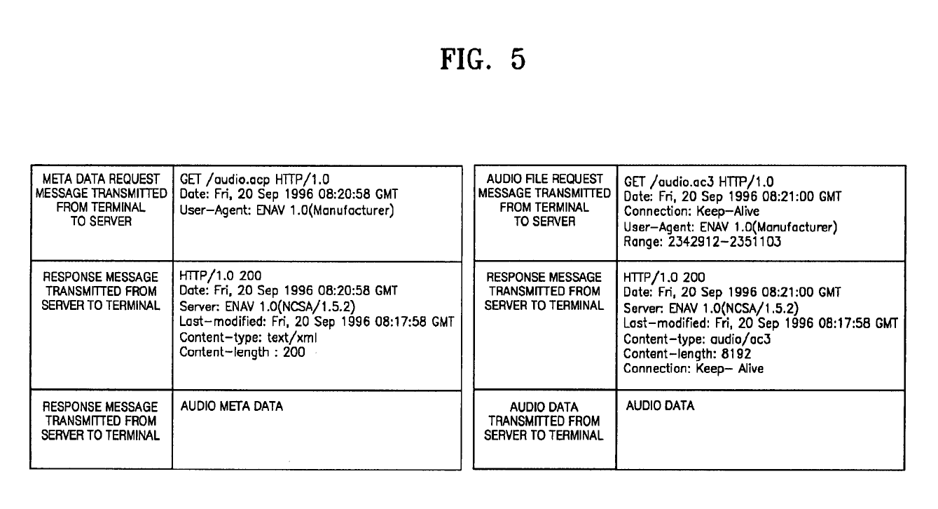

FIG. 5 is a table showing request messages and response messages used to communicate between a terminal and a server. Referring to FIG. 5, messages transmitted from a terminal to a server include a meta data request message and an ac3 file request message, and messages transmitted from the server to the terminal include response messages in response to the request messages.

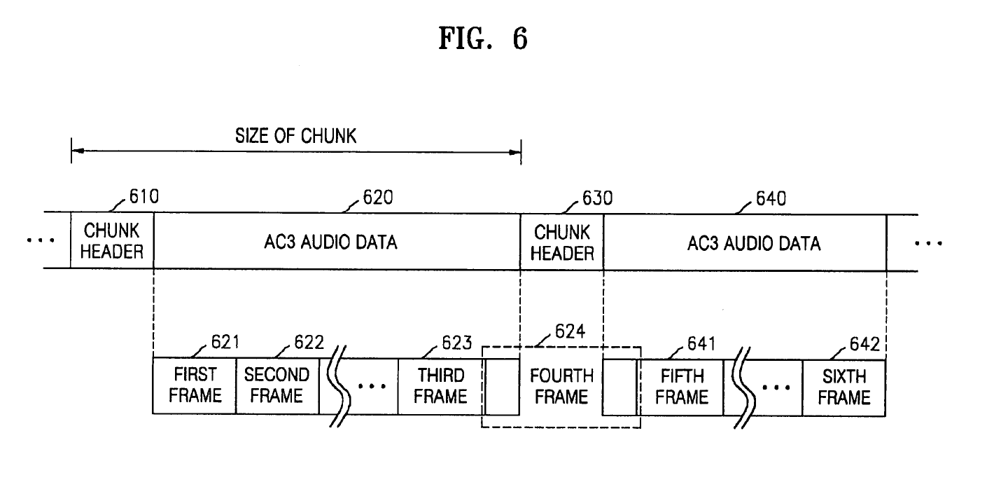

FIG. 6 illustrates the configuration of an audio.ac3 file. The audio.ac3 file shown in FIG. 6 includes chunk header fields 610 and 630 and ac3 audio data fields 620 and 640. The chunk header fields 610 and 630 include synchronization information determining a temporal reference point for reproducing audio. The ac3 audio data fields 620 and 640 include audio data including a plurality of frames. A single audio frame can be included in a single ac3 audio data field, and the single audio frame, such as a fourth frame 624, can be divided into two portions.

A process of calculating a location of audio data that a terminal requests from a server is as follows. The terminal calculates the number of bytes corresponding to an initial position requested by the terminal by analyzing audio meta data audio.acp stored in a buffer memory included in the terminal. For example, if an initial position of a file requested by the terminal is 10 minutes 25 seconds 30 milliseconds, the terminal converts the initial position into a unit of milliseconds in advance. In this case, 10:25:30=625,030 milliseconds. The calculated value is converted into a number of frames using the reproducing time per frame (ms/frame) used in the audio meta data.

The number of frames is calculated as 625,030/32=19,532, and accordingly, an audio data frame following the 19,532th frame is the initial position. Also, a chunk to which the 19,533th frame belongs is calculated. That is, the size of 19,532 frames is calculated as 19,532*(the number of bytes allocated to a frame)=19,532*120=2,343,840 bytes.

The size of data included in the ac3 audio data field 620, not including the chunk header field 610, is (the size of chunk−the size of the chunk header)=8,192−21=8,171. In the above example, dividing the size of total frames by the size of data, 2,343,840/8,171, yields 286 chunks. Therefore, audio data starting from a 287th chunk is received. Here, a location of the 287th chunk converted into a unit of bytes is 286*(the size of chunk), a 2,342,912th byte position.

The terminal transmits the following message including byte position information calculated as described above to the server to receive audio data:

GET/audio.ac3 HTTP/1.0

Date: Fri, 20 Sep. 1996 08:20:58 GMT

Connection: Keep-Alive

User-Agent: ENAV 1.0(Manufacturer)

Range: 2342912-2351103.

The server transmits an audio data file audio.ac3 to the terminal. Here, the ac3 file can be read from a disc or received from the server via a network.

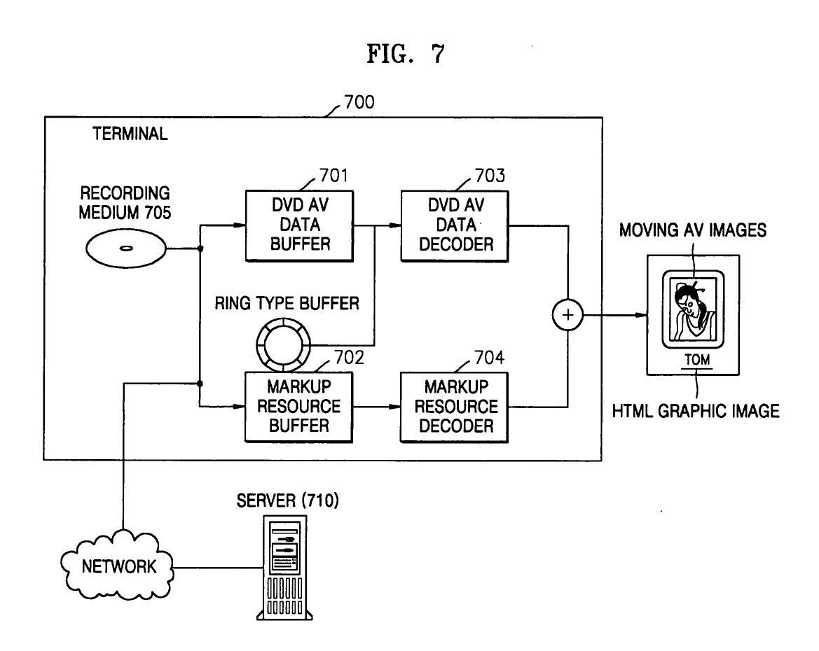

FIG. 7 is a block diagram of a terminal including a ring type buffer. Referring to FIG. 7, a terminal 700 stores a received markup resource data audio.ac3 file in a markup resource buffer 702 included in the terminal 700. The markup resource buffer 702 is a ring type buffer and consecutively receives and stores data in multiple chunk units. A markup resource decoder 704 decodes the audio.ac3 file stored in the ring type markup resource buffer 702 and outputs the decoded audio.ac3 file.

DVD AV data stored in a recording medium 705, such as a disc, is transmitted to a DVD AV data buffer 701, and a DVD AV decoder 703 decodes the DVD AV data. Finally, the DVD AV data decoded by the DVD AV decoder 703 and the audio.ac3 file decoded by the markup resource decoder 704 are reproduced simultaneously. The DVD AV data may also be provided from a server 710 via a network.

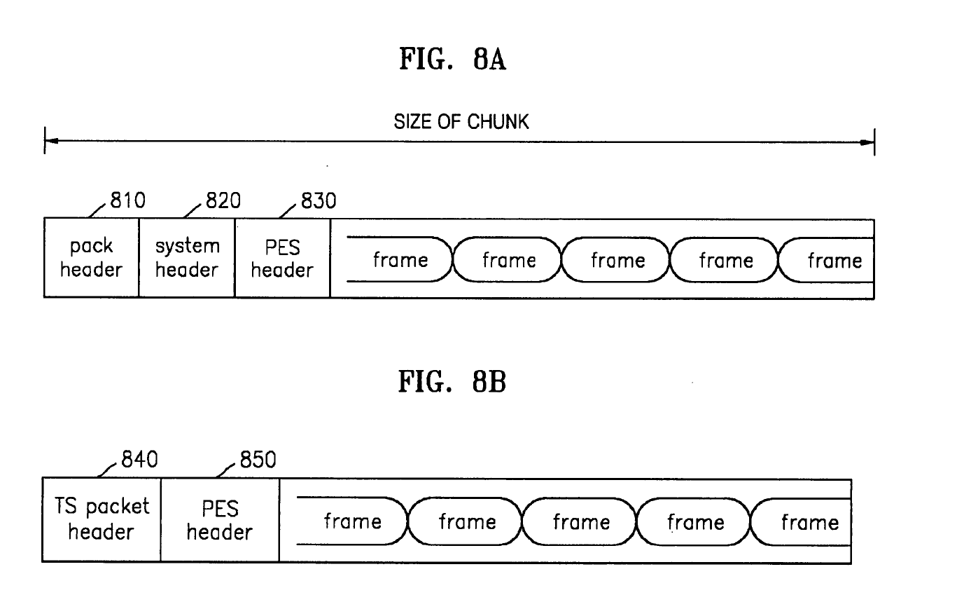

FIGS. 8A and 8B are detailed diagrams of chunk headers according to embodiments of the present invention. A chunk header according to an embodiment of the present invention can be defined to follow the ISO/IEC-13818 Part 1 and a DVD standard such that a DVD file may be easily decoded. As shown in FIG. 8A, in a program stream (PS), the chunk header includes a pack header 810, a system header 820, and a packetized elementary stream (PES) header 830, which are written in ISO/IEC-13818. Also, only one of the pack header 810 and the system header 820 may be included in the chunk header. As shown in FIG. 8B, in a transport stream (TS), the chunk header includes a TS packet header 840 and a PES header 850.

A presentation time stamp (PTS) of chunk data is included in the PES headers 830 and 850. If a fragmented frame exists at an initial position of an audio data field, the PTS indicates an initial position of a fill frame.

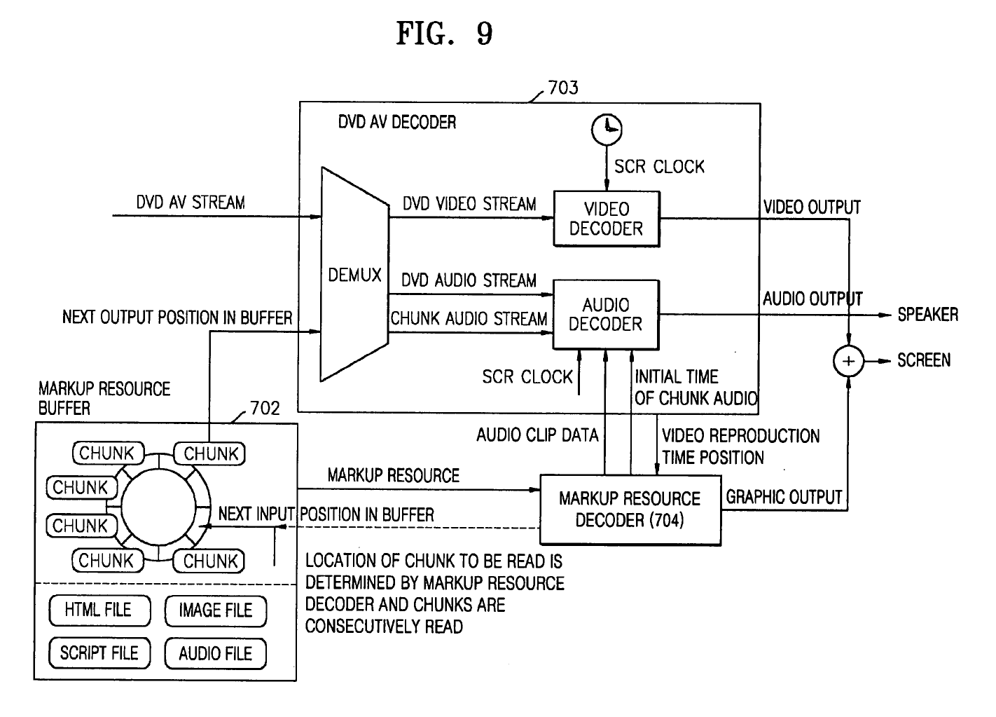

FIG. 9 illustrates a process of reading chunk audio data stored in a buffer, decoding the chunk audio data, synchronizing the decoded chunk audio data with video data, and outputting the synchronized audio and video data.

Synchronization between chunk audio and DVD video is performed as follows. The markup resource decoder 704 confirms a reproducing time position of current DVD video. If it is assumed that the reproducing time position is 10 minutes 25 seconds 30 milliseconds as above, a location of relevant chunk audio can be easily determined. A method of reproducing audio using an ECMAScript will now be described using application programming interfaces (APIs).

[obj].elapsed_Time is API transporting reproducing time position information of the DVD video.

Regardless of whether synchronization with the DVD video is required and whether synchronization with the reproducing time position information of the DVD video is required when the chunk audio is synchronized and reproduced, the API: [obj].playAudioStream (‘http://www.company.com/audio.acp’, ‘10:25:30’, true), designating where the chunk audio is located is required.

The above API indicates that a designated audio meta file, such as ‘http://www.company.com/audio.asp’, has been downloaded and decoded, and when the DVD video is being reproduced for 10 minutes 25 seconds 30 milliseconds until a relevant point in time, reproduction of the chunk audio starts by synchronizing an audio frame obtained by a PTS calculation of a chunk audio stream corresponding to the time.

However, the API below is used when an audio clip is reproduced when the audio clip is reproduced as an infinite loop without synchronization or when the audio clip is reproduced only once:

[obj].playAudioClip(‘http://www.company.com/audio.acp’, -1).

The API is used for downloading and decoding a designated audio meta file from ‘http://www.company.com/audio.acp’, downloading a relevant audio clip to the markup resource buffer 702, and reproducing the audio clip using the infinite loop.

Here, instead of forming a file including the audio meta data, the audio meta data may be calculated using a program language (for example, Javascript, Java language) or a tag language (for example, SMIL, XML), to directly extract information related to frames, and reproduce the audio clip.

Embodiments of the present invention may be applied to not only audio data but also multimedia data configured with a fixed bitrate, for example, media data such as video, text and animation graphic data. That is, if the video, text and animation graphic data have a chunk data configuration, it is possible to reproduce the video, text and animation graphic data in synchronization with the DVD video.

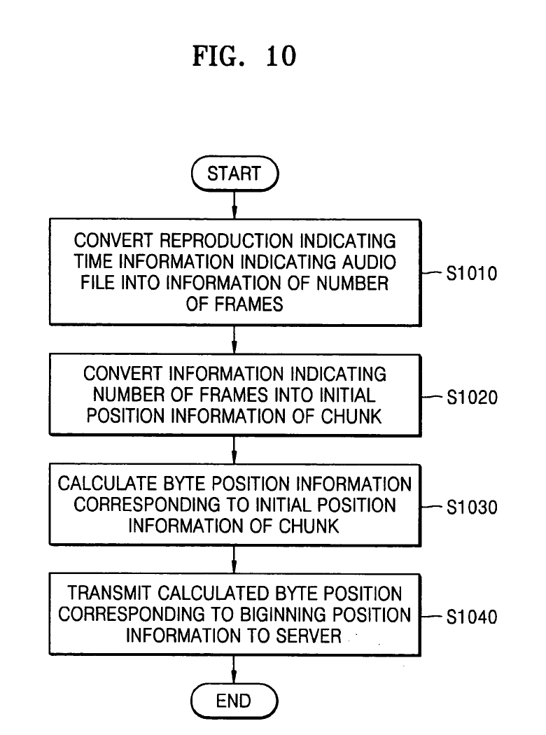

FIG. 10 is a flowchart illustrating a method of calculating an initial position of audio data according to an embodiment of the present invention. Reproduction initial time information of an audio file is converted into the number of frames forming audio data in operation S1010. The number of frames is converted into an initial position of a chunk in operation S1020. Byte position information corresponding to the initial position of the chunk is calculated in operation S1030. The byte position information is transmitted to a server in operation S1040, and the audio data, starting from the desired position, is received from the server.

The invention may also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium may be distributed over network coupled computer systems so that the computer readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

1. A multimedia data reproducing apparatus comprising:
a decoder receiving AV data, decoding the AV data, and reproducing the AV data in synchronization with predetermined markup data related to the AV data; and
a markup resource decoder receiving location information of video data being reproduced by the decoder, calculating a reproducing location of the markup data related to the video data, and transmitting the reproducing location of the markup data to the decoder.

2. The apparatus of claim 1, further comprising a markup resource buffer receiving and storing the markup data.

3. The apparatus of claim 2, wherein the markup resource buffer is a ring type buffer and stores markup resource data related to the AV data in predetermined chunks.

4. The apparatus of claim 3, wherein each chunk comprises:
a chunk header field including synchronization information determining a reference point in time for reproducing audio; and
an audio data field in which audio frames are stored.

5. The apparatus of claim 1, wherein the markup data is audio data.

6. A method of receiving audio data, the method comprising:
receiving meta data including attribute information of the audio data from a server;
calculating initial position information of the audio data, transmission of which is requested, according to the attribute information included in the meta data; and
transmitting the calculated initial position information to the server and receiving the audio data corresponding to the initial position.

7. The method of claim 6, wherein the meta data comprises:
information regarding a compression format of the audio data;
information regarding the number of bytes allocated to a single frame included in the audio data;
time information allocated to the single frame;
information regarding a size of chunk data, which is a transmission unit of the audio data, and information of a size of a chunk header; and
location information regarding the server in which the audio data is stored.

8. The method of claim 6, wherein the calculating of the initial position information comprises:
receiving time information indicating an initial position of the audio data, transmission of which is requested;
converting the time information into information indicating a number of frames forming the audio data;
converting the information indicating the number of frames into initial position information of a chunk forming the audio data; and
calculating byte information corresponding to the initial position information of the chunk.

9. A method of calculating a location of audio data, the method comprising:
converting initial time information of data, transmission of which is requested, into a number of frames included in the audio data;
converting the number of frames into initial position information of a chunk which is a transmission unit of the audio data; and
calculating byte position information corresponding to the initial chunk position information.

10. The method of claim 9, wherein each chunk comprises:
a chunk header field including synchronization information determining a reference point in time for reproducing audio; and
an audio data field in which frames forming the audio data are stored.

11. A recording medium having recorded thereon audio meta data comprising:
information regarding a compression format of audio data;
information regarding a number of bytes allocated to a single frame included in the audio data;
time information allocated to the single frame;
information regarding a size of chunk data, which is a transmission unit of the audio data, and information of a size of a chunk header; and
location information regarding a server in which the audio data is stored.

12. A recording medium having recorded thereon an audio data structure comprising:
a chunk header field including synchronization information determining a reference point in time for reproducing the audio data; and
an audio data field in which frames forming the audio data are stored.

13. The method of claim 12, wherein the chunk header field includes at least one of a pack header field and a system header field, which are defined in an MPEG-2 standard.

14. The method of claim 12, wherein the chunk header field includes a TS packet header field, which is defined in an MPEG-2 standard.

15. The method of claim 12, wherein the chunk header field includes a PES header field, which is defined in an MPEG-2 standard.

16. A computer readable medium having recorded thereon a computer readable program for performing a method of receiving audio data comprising:
receiving meta data including attribute information of the audio data from a server;
calculating an initial position information of the audio data, transmission of which is requested, according to the attribute information included in the meta data; and
transmitting the calculated initial position information to the server and receiving the audio data corresponding to the initial position information.

17. A computer readable medium having recorded thereon a computer readable program for performing a method of calculating a location of audio data comprising:
converting initial time information of data, transmission of which is requested, into a number of frames included in the audio data;
converting the number of frames into initial position information of a chunk which is a transmission unit of the audio data; and
calculating byte position information corresponding to the initial chunk information.

18. A method of reproducing multimedia data, comprising:
receiving AV data, decoding the AV data, and reproducing the AV data in synchronization with predetermined markup data related to the AV data; and
receiving location information of video data being reproduced, calculating a reproducing location of the markup data related to the video data, and transmitting the reproducing location of the markup data to a decoder.

19. The method of claim 18, further comprising:
receiving the AV data via a network using an HTTP protocol:
receiving the predetermined markup data from a storage medium not connected to the network.

20. The method of claim 19, wherein the AV data corresponds to audio data in a different language from corresponding audio data recorded on the storage medium.

21. The method of claim 20, wherein the markup data comprises a video portion of data reproduced from a DVD.

22. The method of claim 19, wherein the network is the Internet.

23. The method of claim 18, further comprising:
receiving the AV data via a network using an HTTP protocol:
receiving the predetermined markup data from a storage medium connected to the network.

24. The method of claim 23, wherein the AV data corresponds to audio data in a different language from corresponding audio data available from the storage medium connected to the network.

25. The method of claim 24, wherein the markup data comprises a video portion of data reproduced from a DVD.

26. The method of claim 22, wherein the network is the Internet.

27. The method of claim 18, further comprising:
receiving the AV data from a first source using an HTTP protocol; and
receiving the predetermined markup data from a second source using other than the HTTP protocol.

28. The method of claim 27, wherein the AV data corresponds to audio data in a different language from corresponding audio data available from the source having the markup data.

29. The method of claim 28, wherein the markup data comprises a video portion of data reproduced from a DVD.

30. The method of claim 27, wherein the first source is a network and the second source is a DVD.

31. The method of claim 6, further comprising:
transmitting the audio data from the server in one of a plurality of chunks; and
reproducing the audio data in synchronization with video data reproduced from a DVD based on the calculated initial position information for a respective chunk.
